(19) United States
(12) Patent Application Publication
(10) Pub. No.: US 2025/0146670 A1
(43) Pub. Date: May 8, 2025

(54) COOKING APPLIANCE AND METHOD OF INDICATING PAN ABSENCE ON A COOKTOP OF A COOKING APPLIANCE

(71) Applicant: Haier US Appliance Solutions, Inc., Wilmington, DE (US)

(72) Inventors: Isabella Mari Cuasay, Louisville, KY (US); Harshita Ravi Shankar, Louisville, KY (US)

(21) Appl. No.: 18/503,413

(22) Filed: Nov. 7, 2023

(51) Int. Cl. F24C 7/08; H05B 6/06; H05B 6/12

(52) U.S. Cl. CPC F24C 7/083; H05B 6/062; H05B 6/1218; H05B 2213/05

(57) ABSTRACT

A cooking appliance includes a cooktop including a plurality of heating elements; a user interface provided on the cooktop, the user interface including a plurality of indicators; and a controller operably coupled with the cooktop and the user interface, the controller configured to perform an operation. The operation includes detecting a cookware item on the cooktop, the cookware item being associated with a first heating element of the plurality of heating elements; determining that the first heating element is active; determining that the cookware item has been removed from the first heating element after determining that the first heating element is active; and adjusting the display in response to determining that the cookware item has been removed from the first heating element, wherein adjusting the display includes activating the plurality of indicators of the display according to a predetermined pattern.

### FIELD OF THE INVENTION

The present subject matter relates generally to cooking appliances, and more particularly to pan detection on induction cooktop appliances.

### BACKGROUND OF THE INVENTION

Traditional cooktop appliances include multiple heating elements (e.g., burners, electrical elements, induction elements) on which cookware items (e.g., pans, pots, etc.) may be placed to perform cooking operations. The heating elements may be energized to certain levels to reach desired temperatures for certain foods or items being cooked. In some instances, multiple heating elements may be used simultaneously to perform a plurality of cooking operations on a single cooktop. Recently, certain cookware items, such as smart cookware items have been introduced which communicate with the cooktop to perform feedback-based cooking operations.

Traditional cooktop appliances also typically include a user interface having a display capable of displaying certain information to users of the appliance. In many cases, these displays are simplistic in nature, for instance including a plurality of seven segment displays, e.g., commonly used to display numbers only. However, certain drawbacks exist to such displays. For instance, certain information cannot be displayed, such as graphical representations, complex sentences, and the like.

Accordingly, a cooking appliance which obviates one or more of the above-mentioned drawbacks would be beneficial. In particular, a cooking appliance including adjustable display features would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cooktop including a plurality of heating elements; a user interface provided on the cooktop, the user interface including a plurality of indicators; and a controller operably coupled with the cooktop and the user interface, the controller configured to perform an operation. The operation may include detecting a cookware item on the cooktop, the cookware item being associated with a first heating element of the plurality of heating elements; determining that the first heating element is active; determining that the cookware item has been removed from the first heating element after determining that the first heating element is active; and adjusting the display in response to determining that the cookware item has been removed from the first heating element, wherein adjusting the display includes activating the plurality of indicators of the display according to a predetermined pattern.

In another exemplary aspect of the present disclosure, a method of operating a cooking appliance is provided. The cooking appliance may include a cooktop including a plurality of heating elements and a user interface including a plurality of indicators. The method may include detecting a cookware item on the cooktop, the cookware item being associated with a first heating element of the plurality of heating elements; determining that the first heating element is active; determining that the cookware item has been removed from the first heating element after determining that the first heating element is active; and adjusting the display in response to determining that the cookware item has been removed from the first heating element, wherein adjusting the display includes activating the plurality of indicators of the display according to a predetermined pattern.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a schematic view of the cooktop appliance of FIG. 1 with an induction heating element of the cooktop appliance shown heating a cooking utensil on the induction heating element.

FIG. 3 provides a close-up view of a control display of the cooktop appliance of FIG. 1.

FIG. 4 provides a close-up view of the control display of the cooktop appliance illustrating a pan absence according to an embodiment of the present disclosure of FIG. 1.

FIG. 5 provides a close-up view of the control display of the cooktop appliance illustrating a pan absence according to an embodiment of the present disclosure of FIG. 1.

FIG. 6 provides a close-up view of the control display of the cooktop appliance illustrating a normal operating display according to an embodiment of the present disclosure of FIG. 1.

FIG. 7 provides a flow chart illustrating a method of operating a cooktop appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

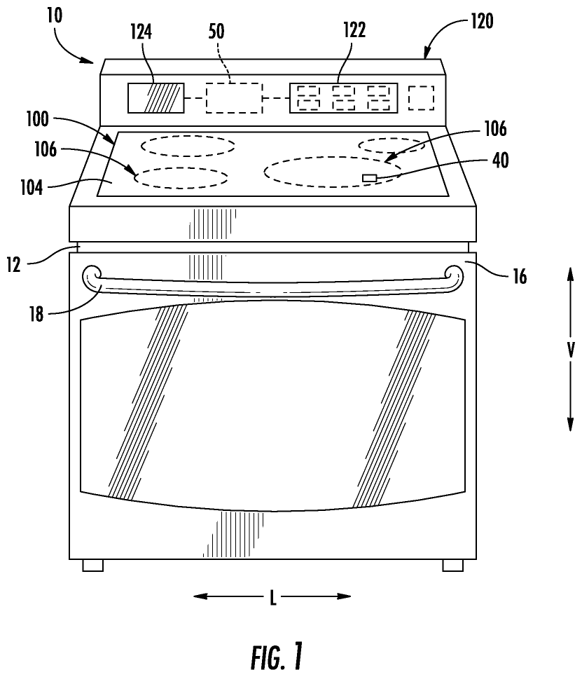

FIG. 1 provides a perspective view of an oven appliance (or cooking appliance) 10 according to an exemplary embodiment of the present disclosure. Cooking appliance 10 is provided by way of example only and is not intended to limit the present subject matter in any aspect. Other cooktop appliances having different configurations, different appearances, or different features may also be utilized with the present subject matter as well (e.g., stand-alone cooktops, individual heating elements, etc.). Thus, the present subject matter may be used with other cooking appliance configurations (e.g., that define one or more cooktop surfaces including a plurality of heating elements or burners). Further, the present subject matter may be used in a stand-alone cooktop, range appliance, or any other suitable appliance.

Cooking appliance 10 generally includes a cooking assembly. In particular, the cooking assembly may include one or more heating elements. For example, in some embodiments, the cooking assembly, and thus cooking appliance 10, includes an insulated cabinet 12 with an interior cooking chamber defined by an interior surface of cabinet 12. The cooking chamber may be configured for the receipt of one or more food items to be cooked. The cooking chamber may be defined by a back wall, a top wall, and a bottom wall spaced from the top wall along the vertical direction V by opposing side walls (e.g., a first wall and a second wall).

Cooking appliance 10 may include a door 16 rotatably mounted to cabinet 12 (e.g., with a hinge—not shown). A handle 18 may be mounted to door 16 and assists a user with opening and closing door 16 in order to access the cooking chamber. For example, a user can pull on handle 18 to open or close door 16 and access the cooking chamber.

Generally, cooking appliance 10 may include a controller 50 in operative communication (e.g., operably coupled via a wired or wireless channel) with one or more other portions of cooking appliance 10 (e.g., heating elements) via, for example, one or more signal lines or shared communication busses, and signals generated in controller 50 operate cooking appliance 10 in response to user input via user inputs 122. Input/Output (“I/O”) signals may be routed between controller 50 and various operational components of cooking appliance 10 such that operation of oven appliance 10 can be regulated by controller 50. In addition, controller 50 may also be in operative communication (e.g., wired or, alternatively, wireless communication) with one or more sensors, such as a first temperature sensor or a second temperature sensor. Generally, either or both the first temperature sensor and the second temperature sensor may include or be provided as a thermistor or thermocouple, which may be used to measure temperature at a location within or proximate to the cooking chamber, for example, and provide such measurements to the controller 50.

Controller 50 is a “processing device” or “controller 50” and may be embodied as described herein. Controller 50 may include a memory and one or more microprocessors, microcontrollers, application-specific integrated circuits (ASICS), CPUs or the like, such as general or special purpose microprocessors operable to execute programming instructions or micro-control code associated with operation of cooking appliance 10, and controller 50 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 50 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Cooking appliance 10 may include a cooktop 100. Cooktop 100 may be disposed on the cabinet 12 such that the total volume of cabinet 12 is generally divided between the cooking chamber and cooktop 100. As shown, cooktop 100 may include a top panel 104. By way of example, top panel 104 may be constructed of glass, ceramics, enameled steel, and combinations thereof. Heating assemblies 106 (e.g., induction heating elements, resistive heating elements, radiant heating elements, or gas burners) may be mounted, for example, on or below the top panel 104. While shown with four heating assemblies 106 in the exemplary embodiment of FIG. 1, cooktop 100 may include any number of heating assemblies 106 in alternative exemplary embodiments. Heating assemblies 106 can also have various diameters. For example, each heating assembly of heating assemblies 106 can have a different diameter, the same diameter, or any suitable combination thereof. Moreover, one or more of the heating assemblies 106 may have varying diameters (e.g., multiple concentric rings offering different power levels and/or heat production).

As shown, certain embodiments of cooking appliance 10 include a user interface panel 120, which may be located as shown, within convenient reach of a user of cooking appliance 10. User interface panel 120 is generally a component that allows a user to interact with cooking appliance 10 to, for example, turn various heating elements (such as heating elements 106) on and off, adjust the temperature or power level of the heating elements, set built-in timers, etc. Although user interface panel 120 is shown in FIG. 1 as being mounted to a backsplash fixed to cabinet 12, alternative embodiments may provide user interface panel 120 at another suitable location (e.g., on a front portion of cabinet 12 above door 16).

In some embodiments, a user interface panel 120 may include one or more user-interface inputs 122 and a graphical display 124, which may be separate from or integrated with the user-interface inputs 122. The user-interface element 122 may include analog control elements (e.g., knobs, dials, or buttons) or digital control elements, such as a touchscreen comprising a plurality of elements thereon. Various commands for a user to select through the engagement with the user-interface inputs 122 may be displayed (e.g., by touchscreen at the inputs 122 or by the graphical display 124), and detection of the user selecting a specific command may be determined by the controller 50, which is in communication with the user-interface inputs 122, based on electrical signals therefrom. Additionally or alternatively, graphical display 124 may generally deliver certain information to the user, which may be based on user selections and interaction with the inputs 122, such as whether one or more heating elements within the cooking chamber are activated or the temperature at which the cooking chamber is set.

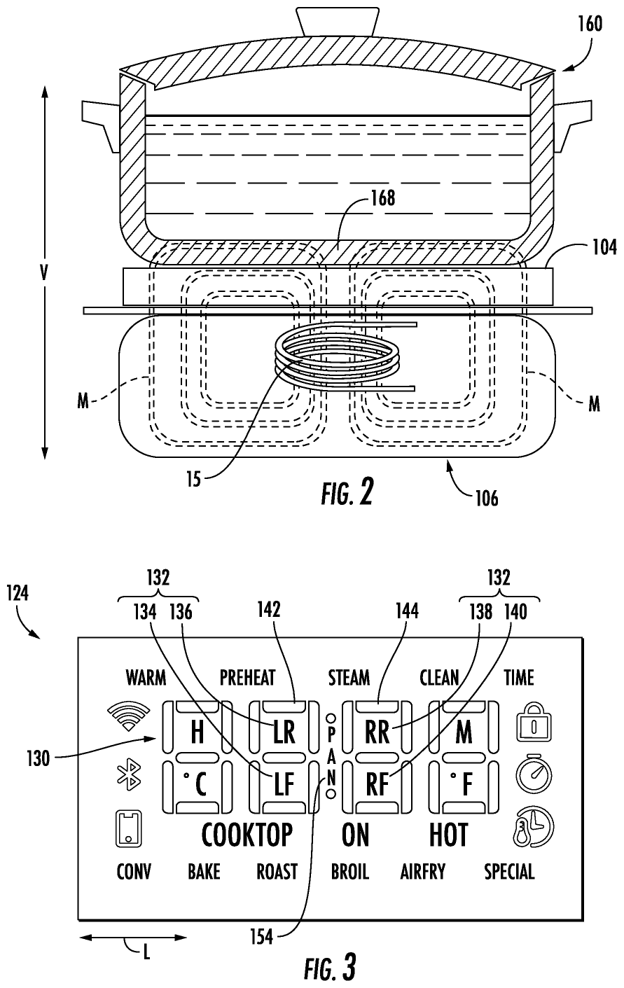

Cooking appliance 10 may include a sensor 40. Sensor 40 may be integrally formed with cooking appliance 10 (e.g., within cooktop 100, etc.). In some embodiments, sensor 40 is operably connected to cooking appliance 10 (e.g., via a port or socket, via a remote connection, etc.). Sensor 40 may monitor one or more attributes relating to a cookware item (e.g., cookware item 160, FIG. 2) or a food item provided within the cookware item. Accordingly, sensor 40 may deliver signals (e.g., voltage signals) to controller 50. The signals may be sent according to a predetermined frequency (e.g., at predetermined time intervals). Thus, controller 50 may analyze the one or more attributes of the cookware item.

For instance, sensor 40 may be configured to determine a material composition of the cookware item. As mentioned above, heating element 106 may be an induction heating element. Accordingly, induction heating element 106 may generate a magnetic field to excite or energize certain cookware items, causing the cookware item to heat up. Induction heating element 106 may thus include sensor 40 to determine, for example, whether the cookware item includes a ferrous or magnetic material (e.g., containing a significant amount of iron). For at least one example, sensor 40 detects whether the cookware item reacts to the magnetic field created by induction heating element 106. For another example, sensor 40 may determine whether the cookware item is present on cooktop 100 or heating element 106.

FIG. 2 provides a schematic view of an induction heating element 106 shown heating a cooking utensil 160 supported on cooking surface 104 according to at least some embodiments. Induction heating element 106 may include a Lenz coil or wire 15. As will be understood by those skilled in the art, appliance 10 may supply a current to Lenz coil 15. As such, current may pass through Lenz coil 15 and Lenz coil 15 may generate a magnetic field (shown with dashed lines M). The magnetic field may be a high frequency circulating magnetic field. As shown in FIG. 2. Lenz coil 15 may be oriented such that magnetic field M is directed towards and through top panel (or cooking surface) 104 to cooking utensil 160. In particular, when magnetic field M penetrates cooking utensil 160, magnetic field M induces a circulating electrical current within cooking utensil 160, e.g., within a bottom wall 168 of cookware item 160. The material properties of cookware item 160 may restrict a flow of the induced electrical current and convert the induced electrical current into heat within cookware item 160. As cookware item 160 heats up, contents of cookware item 160 contained therein heat up as well. In such a manner, induction heating element 106 can cook the contents of cookware item 160.

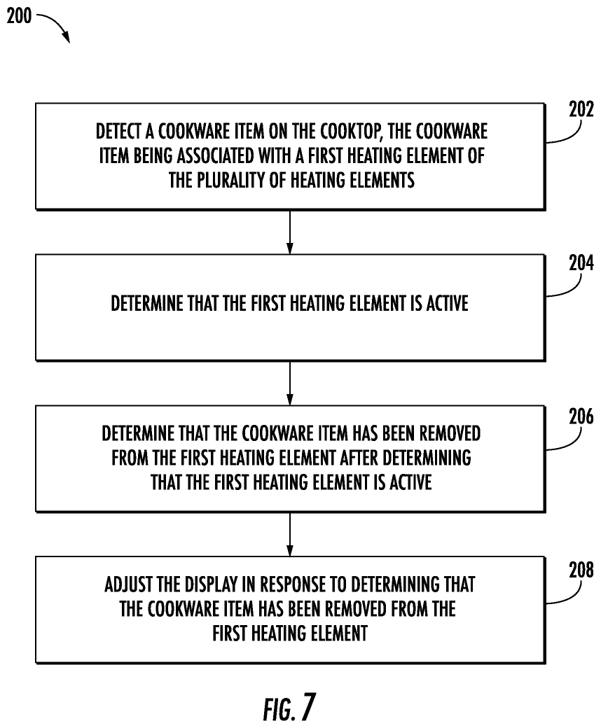

FIGS. 3 through 6 provide schematic examples of graphical display 124. In detail, display 124 may include a plurality of indicators. The plurality of indicators may be graphical representations of information relating to the appliance, such as operations, times, temperatures, connections, statuses, locations, or the like. For instance, each of the plurality of indicators may be provided in the form of a light source. Additionally or alternatively, each of the plurality of indicators may be backlight by a light source. For instance, certain shapes (e.g., outlines) may be formed on a substrate which may then have one or more light sources positioned behind or underneath the substrate to shine through the shapes or outlines on the substrate. For one example, the light sources are light emitting diodes (LEDs). Thus, each LED may be activated or deactivated to illuminate, project, show, or otherwise display a particular indicator.

Display 124 may be a traditional limited display. For instance, with reference to FIGS. 3 through 6, display 124 may include a plurality of seven-segment displays 130. In detail, seven-segment displays 130 may include seven elongated indicators formed into a rectangular shape. It is hereby noted that seven-segment displays are well known in the art, and as such a detailed description thereof will be foregone for the sake of brevity. For example, display 124 may include four seven-segment displays 130, such that information such as a time of day or temperature of appliance 10 (e.g., cooktop 100) may be displayed. Additionally or alternatively, controller 50 may selectively display messages across display 124 (e.g., across the plurality of seven-segment displays 130). Further still, as will be explained in more detail below, the plurality of seven-segment displays 130 may be repurposed such that select segments thereof are illuminated to form or create predetermined shapes.

Display 124 may include a plurality of element indicators 132. For instance, the number of element indicators 132 may be equivalent to the number of heating elements 106 provided on cooktop 100. Thus, each heating element 106 may be respectively associated with an individual element indicator. In detail, the plurality of element indicators 132 may include a first element indicator 134, a second element indicator 136, a third element indicator 138, and a fourth element indicator 140. Additional or alternative element indicators may be included, such as a fifth, a sixth, etc., depending on the number of heating elements included on cooktop 100.

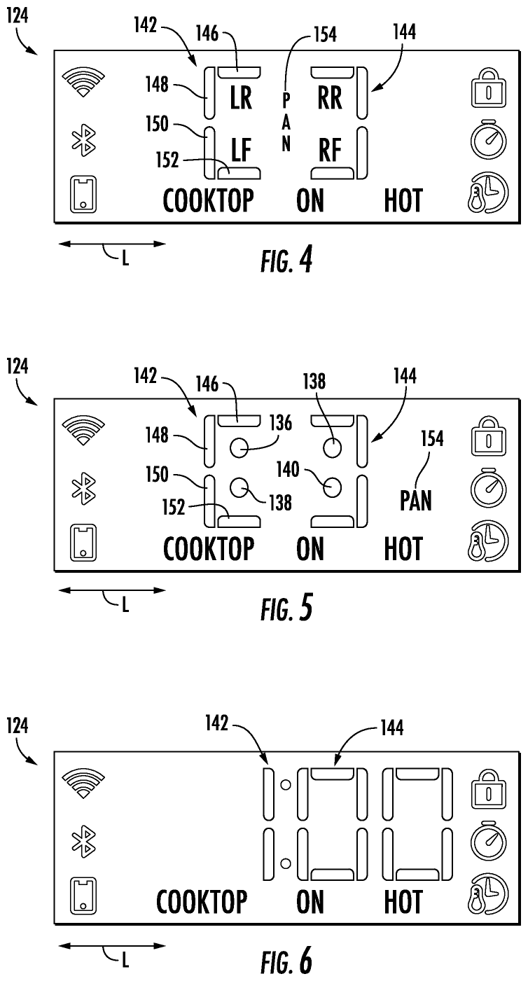

The plurality of element indicators 132 may be positioned within the plurality of seven-segment displays 130. For instance, two element indicators (e.g., first element indicator 134 and second element indicator 136) may be positioned within a first seven-segment display 142. Likewise, two element indicators (e.g., third element indicator 138 and fourth element indicator 140) may be positioned within a second seven-segment display 144. First seven-segment display 142 and second seven-segment display 144 may be directly adjacent to each other (e.g., as shown in FIGS. 3 and 4). However, in some instances, first seven-segment display 142 and second seven-segment display 144 may be spaced apart from each other (e.g., along the lateral direction L). For instance, when more than four heating elements (and thus more than four element indicators) are provided, additional seven-segment displays 130 may be incorporated, in which the additional element indicators may be positioned.

The plurality of element indicators 132 may be represented in any suitable manner. For instance, with reference to FIGS. 3 and 4, the plurality of element indicators 132 may be letters. The letters may indicate or describe a relative location of the associated heating element 106. As shown, first element indicator 134 may be provided as “LF” signifying a left front heating element 106. Similarly, second element indicator 136 may be provided as “LR” signifying a left rear heating element 106. Accordingly, third element indicator 138 may be provided as “RR” signifying a right rear heating element and fourth element indicator 140 may be provided as “RF” signifying a right front heating element 106.

In alternative embodiments, the plurality of element indicators 132 may be represented with symbols. Referring now briefly to FIG. 5, each of the plurality of element indicators 132 may be represented by a circle. It should be noted that the plurality of element indicators 132 may be represented by any suitable shape, figure, icon, character, series of characters, or the like, and the disclosure is not limited to the examples provided herein. For instance, the plurality of element indicators 132 may be formed by portions of one of the plurality of seven-segment displays 130. For one example, two segments within a single seven-segment display may be activated according to a predetermined pattern (e.g., a flashing pattern, a pulsing pattern, a fading pattern, etc.) to represent an element indicator 132. As mentioned above and described further below, at least two of the plurality of seven-segment displays 130 may be adjusted to form a shape, such as a rectangle.

Referring still to FIGS. 4 and 5, first seven-segment display 142 and second seven-segment display 144 are shown in an adjusted form. As seen, first seven-segment display 142 and second seven-segment display 144 collectively form a rectangle. The rectangle may represent cooktop 100 (e.g., a graphical representation). In detail, first seven-segment display 142 may be selectively illuminated to a “C” shape while second seven-segment display 144 is selectively illuminated to a reverse or backwards “C” shape. Thus, the formed rectangle may visually represent cooktop 100 on display 124. In some instance, the plurality of element indicators 132 are positioned within the formed rectangle (e.g., as seen in FIGS. 4 and 5). However, in additional or alternative embodiments, portions of the first seven-segment display 142 and second seven-segment display 144 may be implemented as element indicators 132 (e.g., as mentioned above).

As mentioned, each of first seven-segment display 142 and second seven-segment display 144 may include individual segments. For purposes of the formed rectangle, the individual segments may include a first segment 146, a second segment 148, a third segment 150, and a fourth segment 152. Hereinafter, a description of the four segments of first seven-segment display 142 forming half of the rectangle will be described with the understanding that a similar description applied to second seven-segment display 144.

First segment 146 and second segment 148 may be positioned at a top side and lateral side of first seven-segment display 142 (respectively, e.g., as seen in FIG. 4). For instance, first segment 146 may extend laterally along the top of first seven-segment display 142 and second segment 148 may extend perpendicular to first segment 146 at a lateral edge (e.g., left edge) of first seven-segment display 142. Accordingly, third segment 150 may extend parallel with second segment 148 along the lateral (e.g., left) edge of first seven-segment display 142 (e.g., below second segment 148) and fourth segment 152 may extend laterally (e.g., parallel with first segment 146) and may be positioned at a bottom side of first seven-segment display 142, respectively. In some instances, first element indicator 136 may be represented collectively by first segment 146 and second segment 148 (e.g., as mentioned above). Likewise, second element indicator 138 may be represented collectively by third segment 150 and fourth segment 152.

Display 124 may include additional or alternative indicators, such as a PAN indicator 154. PAN indicator 154 may represent the presence (or absence) of a cookware item (e.g., a cooking pan or pot) on cooktop 100. A location of PAN indicator 154 may vary according to specific embodiments. For instance, PAN indicator 154 may be positioned between first seven-segment display 142 and second seven-segment display 144 (FIG. 4) or laterally adjacent to second seven-segment display 144 (FIG. 5). Accordingly, PAN indicator 154 and one or more of the element indicators 132 may illuminate collectively, as will be described below.

Now that the general descriptions of an exemplary appliance have been described in detail, a method 200 of operating an appliance (e.g., oven appliance 10 or cooktop 100) will be described in detail. Although the discussion below refers to the exemplary method 200 of operating oven appliance 10 or cooktop 100, one skilled in the art will appreciate that the exemplary method 200 is applicable to any suitable domestic appliance capable of performing a cooking operation (e.g., such as a stand-alone cooktop, an independent burner, etc.). In exemplary embodiments, the various method steps as disclosed herein may be performed by controller 50 and/or a separate, dedicated controller. FIG. 7 provides a flow chart illustrating a method of operating an exemplary cooktop, e.g., cooktop 100. Hereinafter, method 200 will be described with specific reference to FIG. 7.

At step 202, method 200 may include detecting a cookware item on the cooktop, the cookware item being associated with a first heating element. For instance, the cookware item may be detected via a sensor (e.g., sensor 40). The sensor may be positioned or provided within the cooktop (e.g., cooktop 100). In some instances, the cookware item may be paired with the first heating element (e.g., in the instance of a smart pan).

At step 204, method 200 may include determining that the first heating element is active. For instance, after detecting or determining that the cookware item is present on the cooktop (e.g., via a sensor, a user input, etc.), the method 200 further determines that an operation has been initiated such that the heating element (e.g., induction element) is activated. The activation of the element may be determined by a user input, such as a manipulation of a knob, button, or the like on the user interface. Additionally or alternatively, the activation of the element may be determined according to an output of electromagnetic radiation from the element (e.g., Lenz coil 15).

At step 206, method 200 may include determining that the cookware item has been removed from the first heating element. In detail, after confirming that the cookware item is associated with the first heating element and confirming that the first heating element is active and performing an operation (e.g., heating operation), the method may continually monitor the presence of the cookware item with regard to the first heating element. In some instances, a sensor (e.g., sensor 40) may regularly provide signals to the controller regarding the presence or absence of the cookware item. However, it should be noted that any suitable monitoring or sensing method may be incorporated to determining the presence or absence of the cookware item.

The method 200 may determine that the cookware item has been absent from the first heating element for a predetermined length of time. For instance, the controller may determine that a number of signals indicating the absence of the cookware item have been received in succession. Additionally or alternatively, the controller may calculate, interpolate, or otherwise determine the length of time that the first heating element has been active without the cookware item being positioned thereon. The length of time is compared against the predetermined length of time. In some instances, the predetermined length of time is between about 5 seconds and about 10 seconds. The values given here are provided by way of example only, and any suitable predetermined length of time may be incorporated. For instance, the user may manually enter a predetermined length of time (e.g., via the user interface).

At step 208, method 200 may include adjusting the display in response to determining that the cookware item has been removed from the first heating element. In detail, method 200 may include providing a notification or indication to the user that the cookware item has been removed from the cooktop, specifically from the first heating element. As mentioned above, the appliance may include a limited interface including a plurality of seven-segment displays. Accordingly, at step 208, one or more of the seven-segment displays may be manipulated, adjusted, or otherwise activated according to a predetermined pattern.

Referring back to FIGS. 4 and 5, for instance, the display may be adjusted such that a predetermined shape is formed using two of the seven-segment displays. The predetermined shape may be a rectangle. For example, a first seven-segment display is modified to a “C” shape while a second seven-segment display is modified to a reverse or backwards “C” shape. Collectively, an interior space may be defined between the first seven-segment display and the second seven-segment display. The first and second seven-segment displays may be immediately adjacent each other on the display. Additionally or alternatively, the first and second seven-segment displays may be spaced apart from each other on the display. Accordingly, the predetermined shape (e.g., the rectangle) may vary in size.

The interior space of the predetermined shape may represent the cooktop. Thus, the selection of the first and second seven-segment displays may depend on a size of the cooktop. In some instances, a third seven-segment display may be incorporated. In still further instances, the third and a fourth seven-segment display me be incorporated. In such instances, a top and bottom segment of each of the third and fourth seven-segment displays may be illuminated or activated. For example, the first and second seven-segment displays may be positioned laterally on either side of the third and fourth seven-segment displays. Thus, an elongated rectangle (e.g., elongated along the lateral direction L) may be formed.

Further, as mentioned above, the plurality of indicators may include one or more element indicators (e.g., a first element indicator, a second element indicator, etc.) as well as a PAN indicator. Accordingly, at step 208, an element indicator may be activated. The element indicator may be a first element indicator associated with the first heating element (e.g., as described above). The first element indicator may be activated according to a predetermined pattern. For instance, the first element indicator may be flashed, pulsed, or activated at a predetermined rate, intensity, brightness, or the like. Additionally or alternatively, the PAN indicator may be activated or illuminated. Accordingly, the plurality of indicators may be activated according to a predetermined pattern. Advantageously, the user may be notified (e.g., graphically) as to the absence of the pan associated with the first heating element. Additionally or alternatively, two or more element indicators may be activated. For instance, when two cookware items associated with individual heating elements are removed from the respective heating elements, each corresponding element indicator may be activated. Thus, multiple heating elements may be monitored simultaneously.

In some instances, a tone is emitted upon determining that the cookware item has been removed from the first heating element. For instance, as the user interface (e.g., the plurality of indicators) is adjusted, the tone may be played simultaneously to alert the user to the absence of the cookware item.

Method 200 may include reverting the display to a previous state upon determining that the cookware item has been returned to the heating element. For instance, after adjusting the display to provide the alert, method 200 may determine that the cookware item has been returned to the heating element. Additionally or alternatively, method 200 may determine that the heating element has been deactivated (e.g., turned off, de-energized, etc.). The display (e.g., the plurality of indicators) may be returned to a previous state (e.g., a normal operating state). For instance, the seven-segment displays may return to displaying numbers (e.g., temperatures, time, timer setting, etc.). Accordingly, the element indicator or indicators as well as the PAN indicator may be deactivated, turned off, or otherwise not illuminated in response to determining that the cookware item has been returned to the heating element or the heating element has been deactivated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cooktop comprising a plurality of heating elements;
a user interface provided on the cooktop, the user interface comprising a plurality of indicators; and
a controller operably coupled with the cooktop and the user interface, the controller configured to perform an operation, the operation comprising:
detecting a cookware item on the cooktop, the cookware item being associated with a first heating element of the plurality of heating elements;
determining that the first heating element is active;
determining that the cookware item has been removed from the first heating element after determining that the first heating element is active; and
adjusting the display in response to determining that the cookware item has been removed from the first heating element, wherein adjusting the display comprises activating the plurality of indicators of the display according to a predetermined pattern.

2. The cooking appliance of claim 1, wherein the plurality of indicators comprises a plurality of light emitting diodes (LEDs) arranged into a plurality of seven-segment displays.

3. The cooking appliance of claim 2, wherein activating the plurality of indicators according to the predetermined pattern comprises:
activating portions of at least two seven-segment displays such that the at least two seven-segment displays form a rectangle.

4. The cooking appliance of claim 3, wherein the plurality of indicators comprises:
a first element indicator associated with the first heating element.

5. The cooking appliance of claim 4, wherein activating the plurality of indicators according to the predetermined pattern comprises:
flashing the first element indicator at a predetermined rate.

6. The cooking appliance of claim 4, wherein the first element indicator is positioned within the rectangle formed by the at least two seven-segment displays.

7. The cooking appliance of claim 6, wherein the positioning of the first element indicator within the rectangle corresponds with a positioning of the first heating element on the cooktop.

8. The cooking appliance of claim 1, wherein the cooktop is an induction cooktop, the cooking appliance further comprising:
a sensor positioned within the cooktop, the sensor configured to detect a presence or absence of the cookware item.

9. The cooking appliance of claim 1, wherein determining that the cookware item has been removed from the first heating element comprises:
determining that the cookware item is absent from the first heating element for a predetermined length of time.

10. A method of operating a cooking appliance, the cooking appliance comprising a cooktop comprising a plurality of heating elements and a user interface comprising a plurality of indicators, the method comprising:
detecting a cookware item on the cooktop, the cookware item being associated with a first heating element of the plurality of heating elements;
determining that the first heating element is active;
determining that the cookware item has been removed from the first heating element after determining that the first heating element is active; and
adjusting the display in response to determining that the cookware item has been removed from the first heating element, wherein adjusting the display comprises activating the plurality of indicators of the display according to a predetermined pattern.

11. The method of claim 10, wherein the plurality of indicators comprises a plurality of light emitting diodes (LEDs) arranged into a plurality of seven-segment displays.

12. The method of claim 11, wherein activating the plurality of indicators according to the predetermined pattern comprises:
activating portions of at least two seven-segment displays such that the at least two seven-segment displays form a rectangle.

13. The method of claim 12, wherein the plurality of indicators comprises:
a first element indicator associated with the first heating element.

14. The method of claim 13, wherein activating the plurality of indicators according to the predetermined pattern comprises:
flashing the first element indicator at a predetermined rate.

15. The method of claim 13, wherein the first element indicator is positioned within the rectangle formed by the at least two seven-segment displays.

16. The method of claim 15, wherein the positioning of the first element indicator within the rectangle corresponds with a positioning of the first heating element on the cooktop.

17. The method of claim 10, wherein the cooktop is an induction cooktop, the cooking appliance further comprising:
a sensor positioned within the cooktop, the sensor configured to detect a presence or absence of the cookware item.

18. The method of claim 10, wherein determining that the cookware item has been removed from the first heating element comprises:
determining that the cookware item is absent from the first heating element for a predetermined length of time.
